(19) United States
(12) Patent Application Publication
(10) Pub. No.: US 2005/0152764 A1
(43) Pub. Date: Jul. 14, 2005

(54) Fastener

(76) Inventor: Nicholas Jackson JR., Davisburg, MI (US)

Correspondence Address: DICKINSON WRIGHT PLLC, 1901 L. STREET NW, SUITE 800, WASHINGTON, DC, 20036, US

(21) Appl. No.: 10/753,867

(22) Filed: Jan. 8, 2004

(51) Int. Cl. F16B 13/06

(52) U.S. Cl. 411/45

(57) ABSTRACT

A one piece fastener capable of being secured to a substrate member and having an uncoupled position and a coupled position. The fastener includes an outer member defining a cavity and an inner member integrally formed with said outer member. The inner member is disposed in the cavity of the outer member wherein the outer member is moved along a longitudinal axis from an uncoupled position to a coupled position relative to said inner member. The inner member includes living hinges permitting the outer and inner members to move relative to one another. The fastener also includes at least one locking mechanism for locking the fastener in a coupled position. The outer member includes a head and recess for receiving a portion of the inner member in the coupled position and permitting the fastener to be released from the coupled position and reused.

### BACKGROUND OF THE INVENTION

The present invention is directed to a fastener and more particularly to a fastener for mounting items, such as panels and electrical or fluid lines to a substrate member, such as a vehicle body or vehicle door.

Manufacturers use a variety of one-piece fasteners to secure items, such as door panels to vehicle doors, or electrical lines to a vehicle body. One-piece fasteners are generally easy to manufacture through molding. Typically these one-piece fasteners are secured to the substrate member with a plurality of ribs that fold inward during insertion and then extend to lock behind the substrate member. A mounting member, such as a door panel, may be secured between the fastener and substrate member. One problem with these one-piece fasteners is that in order to remove the one-piece fastener so that the mounting member may be removed, the ribs on the fastener must be deformed. If the ribs are deformed, the one-piece fastener generally cannot be reused and must be replaced with a new fastener to secure the mounting member to the substrate member.

To overcome some of the problems associated with one-piece fasteners, some manufactures use two-piece fasteners. Two-piece fasteners generally include an outer member and an inner member. To secure a mounting member to a substrate member, the two-piece fastener is inserted into aligned holes defined by the substrate member and the mounting member. With the outer member stationary relative to the substrate member and mounting member, the inner member is inserted along a longitudinal axis of the fastener to expand the outer member to a diameter larger than the substrate hole in the substrate member. More specifically, the outer member generally includes a pair of opposing arms that are expanded by the inner member. While two-piece fasteners are typically reusable, they are expensive to manufacture and time consuming to assemble as compared to one-piece fasteners. Two piece fasteners can also be very difficult to package and transport in that the inner member can fall out of the outer member during shipment. Another problem with two piece fasteners is that the fastener may be difficult to remove once secured to the substrate member because the outer member must be retracted toward the longitudinal axis before the fastener may be removed. Two-piece fasteners are also generally only adaptable to securing flat panels to the substrate member and not vehicle lines such as electric or fluid lines to a substrate member.

Therefore, a fastener that is cost effective, easy to assemble, capable of being reused, and capable of securing a variety of objects having varying sizes and shapes to a substrate member is needed.

### SUMMARY OF THE INVENTION

The present invention overcomes the problems of a one piece fastener by providing for a one piece reusable fastener including a notch for easily releasing the fastener from a substrate. According to the present invention, there is provided a fastener capable of being secured to a substrate member and having an uncoupled position and a coupled position. The fastener includes an outer member defining a cavity and an inner member integrally formed with said outer member. The inner member is disposed in the cavity of the outer member wherein the outer member is moved along a longitudinal axis from an uncoupled position to a coupled position relative to said inner member. The inner member includes living hinges permitting the outer and inner members to move relative to one another. The fastener also includes at least one locking mechanism for locking the fastener in a coupled position. The outer member includes a head and recess for receiving a portion of the inner member in the coupled position and permitting the fastener to be released from the coupled position and reused.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective view of the fastener in an uncoupled position;

FIG. 2 is a section view of the fastener in an uncoupled position;

FIG. 3 is a section view of the fastener in a coupled position;

FIG. 4 is a side elevational view, partially in section, of the fastener coupling a panel member to the substrate member; and

FIG. 5 illustrates an alternative fastener embodiment for coupling a tubular member to the substrate member.

### DETAILED DESCRIPTION OF THE PREFERRED EMBODIMENT

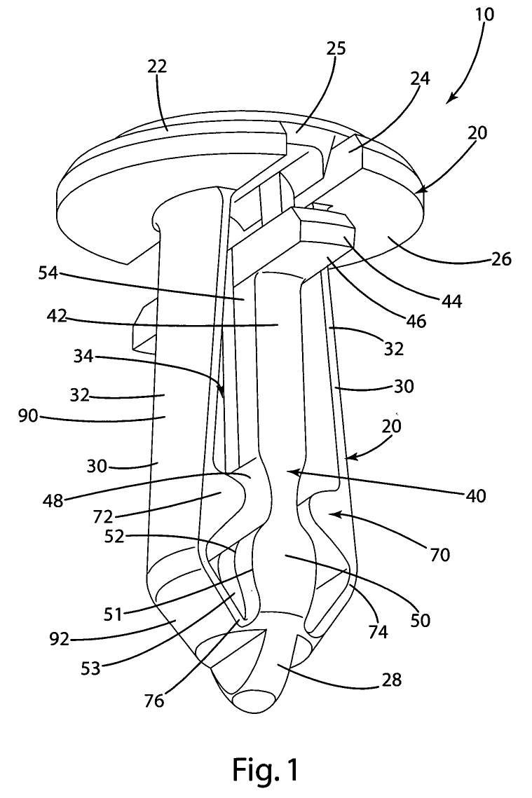

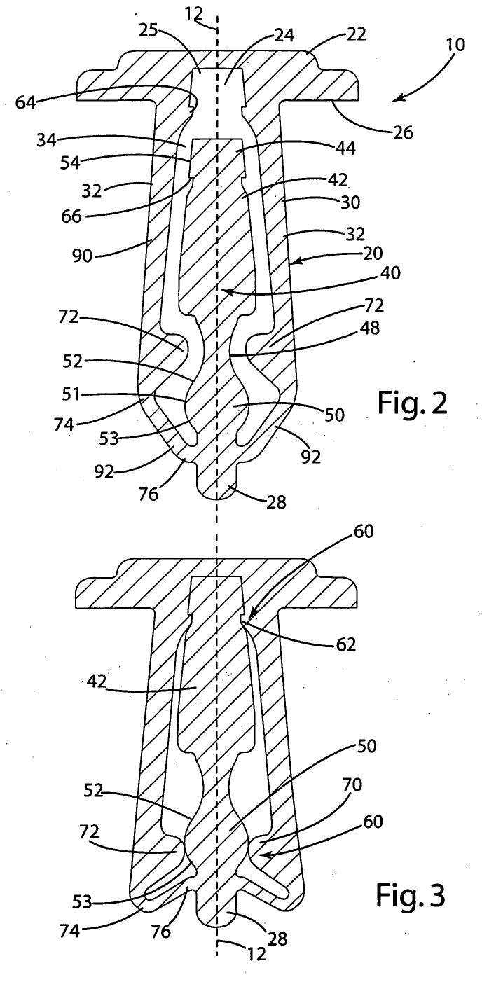

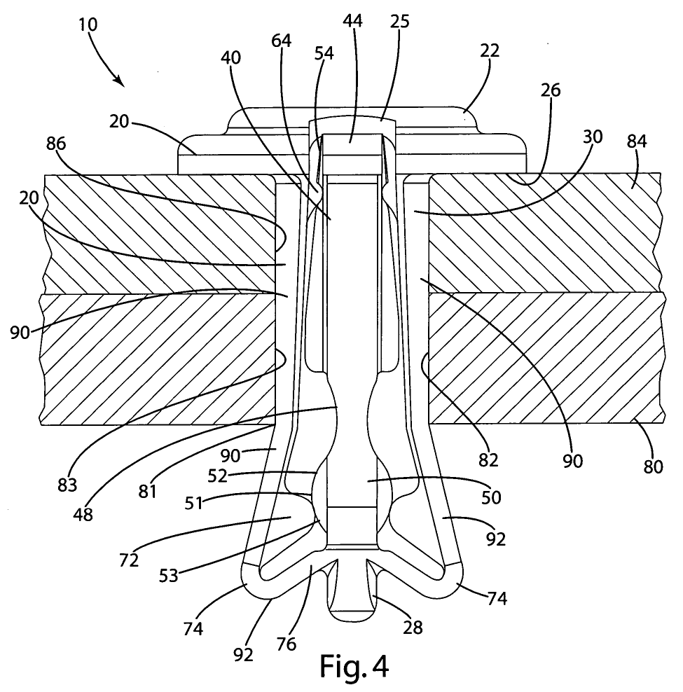

A fastener 10 constructed in accordance with the illustrated embodiment is shown in FIGS. 1-2 in an uncoupled position and in a coupled position in FIGS. 3-4. The fastener 10 is configured to attach an item 84 to a substrate member 80 (FIG. 4). The fastener 10 has a variety of applications and is particularly suited for attaching door panels or other panels to a portion of a vehicle body or vehicle interior, or to attach a tubular member, such as an electrical line, vacuum line, or fluid line to a portion of a vehicle member.

The fastener 10 includes a longitudinal axis 12, an outer member 20 and an inner member 40. The outer member 20 is configured to move along the longitudinal axis relative to the inner member 40 and includes a sleeve head 22, an insertion tip 28, and an intermediate member 30. The sleeve head 22 may be configured depending on the application, and in the illustrated embodiment includes a sleeve head recess 24, a pry notch 25, and a sleeve seat 26. The sleeve seat 26 is configured to engage the substrate member 80 or the mounting member 84 in the coupled position and the sleeve head recess 24 is configured to receive a portion of the inner member 40 in the coupled position as hereinafter described. Although not needed to secure an item to the substrate member 80, the pry notch 25 assists in the release of the outer member 20 from the coupled position by allowing opposing forces to be applied to the outer member 20 and inner member 40 so that the outer member 20 may be moved, when desired, from the coupled position to the uncoupled position along the longitudinal axis and relative to the inner member 40 and substrate member 80.

The intermediate member 30 extends between the sleeve head 22 with the insertion tip 28 and is formed of a flexible material so that as the fastener 10 is moved from the uncoupled position to the coupled position. In the coupled position, the intermediate member 30 is displaced to a size greater than the substrate hole 82 in the substrate member 80 to securely retain the fastener 10 to the substrate member 80. In the illustrated embodiment, the intermediate member 30 includes a pair of opposing arms 32 that define a cavity 34 therebetween. The fastener 10 may include any number of arms. As discussed in greater detail below, the intermediate member 30 also includes lower projections 72 and upper projections 64 that engage the inner member 40 to displace the intermediate member 30 of the outer member 20 away from the longitudinal axis 12 as the outer member is moved from the uncoupled position to the coupled position.

The fastener 10 is integrally molded as a one-piece fastener and uses living hinges to allow the arms 32 to be displaced laterally relative to the longitudinal axis 12 as the fastener 10 is moved from the uncoupled position to the coupled position and, if desired, back to the uncoupled position. The arms 32 include a first section 90 extending from the head 22 and a second section 92 extending from the insertion tip 28. A first living hinge 74 is located between the first section 90 and second section 92. A second living hinge 76 joins the second section 92 to the insertion tip 28. The living hinges 74 and 76 work in conjunction to allow the outer member 20 to move relative to the inner member 40. The first living hinge 74 allows the first and second sections 90 and 92 to articulate relative to each other while the second living hinge 76 allows the arms 32 to articulate relative to the inner member 40. It should be appreciated that while the above described arm configuration is suitable for many applications, various modifications may be made to design the fastener for a particular application. For example, the length of the first and second sections 90, 92 may be varied to adjust the location of the first living hinge 74. Further the arms 32 may also be configured to allow deflection of the first section 90 against the substrate hole 82 to more securely engage the substrate member 80.

The inner member 40 is formed integrally with the outer member 20 and extends from the insertion tip 28 toward the sleeve head 22 within the cavity 34. The inner member 40 includes a cam 50, pockets 48 and a shank 42. The shank 42 includes a shank head 44 (FIG. 1) configured to be received within the sleeve head recess 24 and an angled surface 54. The shank head 44 includes a shank seat 46 that is approximately co-planar with the sleeve head seat 26 in the coupled position. The cam 50 and angled surface 54 operatively engage portions of the outer member 20 as the outer member is moved from the uncoupled position to the coupled position so that the arms 32 of the outer member 20 are displaced away from the longitudinal axis 12. More specifically, the cam 50 on the inner member 40 operatively engages the lower projections 72 on the intermediate member 30 and the opposed angled surfaces 54 operatively engage the upper projections 64 on the intermediate member to displace the intermediate member 30 away from the longitudinal axis 12.

The fastener 10 further includes a locking mechanism 60 to releasably secure the fastener in the coupled position. The locking mechanism 60 includes a first locking mechanism 62 and a second locking mechanism 70. The first locking mechanism 62 includes at least one upper projection 64 located on either the intermediate member 30 or shank 42, and at least one upper recess 66 located on the other of the intermediate member and shank. In the illustrated embodiment, the upper projections 64 are located on the opposing arms 32 and the upper recesses 66 are located on the shank 42, near the shank head 44. As illustrated in FIG. 3, the angled surface 54 operatively engages the upper projections 64 of the first locking mechanism 62 to displace the outer member 20 from the longitudinal axis 12. The location, size and shape of the first locking mechanism 62 and angled surface 54 may be configured to expand the outer member 20 to engage the inner surface 83 of the substrate hole 84, to more securely retain the fastener 10 to the substrate member 80. The second locking mechanism 70 works in conjunction with the cam 50 and lower projections 72, as described below.

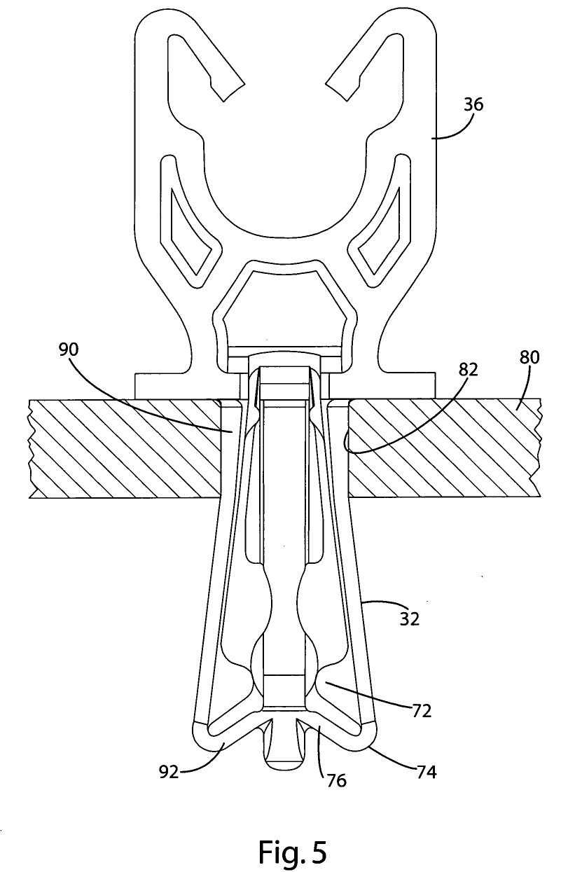

The operation of the fastener 10 will now be described in greater detail. The size, shape and head style of the fastener 10 is selected based on, for example, the size and shape of substrate hole 82, the shape of the item to be secured and the retention force needed. The size of the fastener 10 may vary so that the fastener, specifically the outer member 20, engages or approximately engages the mounting hole 86 and substrate hole 82 as it is inserted. In the illustrated embodiment, the fastener 10 is configured to retain a mounting member 84 having a flat portion which the sleeve seat 26 and shank seat 46 engage (FIG. 4). An alternative embodiment is illustrated in FIG. 5 where the sleeve head 22 is configured to receive a tubular member such as a vehicle electrical line or vacuum line. The method of coupling the fastener 10 to the substrate member 80 will first be described in connection with securing a mounting member 84 to the substrate member 82, as illustrated in FIG. 4.

With the proper fastener 10 selected, the mounting hole 86 is aligned with the substrate hole 82. The fastener 10, in the uncoupled position, is inserted into the mounting hole 86 and substrate hole 82 until the shank seat 46 engages the mounting member 84. With the shank seat 46 engaging the mounting member 84 and the sleeve head 22 spaced from the mounting member 84, a force is applied to the sleeve head 22 along the longitudinal axis 12 and toward the substrate member 80 to move the fastener 10 from the uncoupled position (FIGS. 1-2) to the coupled position (FIGS. 3-4). The applied force causes the outer member 20 to move along the longitudinal axis 12 relative to the inner member 40, as well as the substrate member 80 and to expand laterally away from the longitudinal axis. More specifically, as the outer member 20 moves along the longitudinal axis 12 from the uncoupled position to the coupled position, the intermediate member 30 moves relative to the inner member 40 and the substrate member 80. The inner member 40 and substrate member 80 are generally stationary relative to each other as the fastener 10 is moved from the coupled position to the uncoupled position.

As the outer member moves to the coupled position illustrated in FIG. 3, the outer member 20, specifically the intermediate member 30, is displaced laterally from the longitudinal axis 12. While in the uncoupled position, the lower projections 72 rest in the pockets 48 on the shank 42. As the outer member 20 moves to the coupled position, the lower projections 72 engage the cam 50 to force the intermediate member 30, specifically the arms 32, away from the longitudinal axis 12. It should be appreciated that the lower projections 72 are also acting on cam 50 as a cam. More specifically, the upper cam surface 52 on the cam 50 forces the arms 32 laterally away from the longitudinal axis 12. As the fastener 10 approaches the coupled position, the lower projections 72 pass the maximum cam diameter 51 and are displaced slightly inward toward the longitudinal axis 12 to act as the second locking mechanism 70, thereby assisting in preventing the fastener from accidentally moving from the coupled position to the uncoupled position. During the movement to the coupled position, the upper projections 64 also engage the angled surface 54. As the fastener approaches the coupled position, the upper projections 64, are displaced in the upper recesses 66 creating the first looking mechanism. As the first and second locking mechanisms 62, 70 are locked, the shank head 44 is also disposed within the sleeve head recess 24 and the sleeve seat 26 and shank seat 46 are approximately coplanar with the sleeve seat 26 and the shank seat 46, preferably though not necessarily, engaging the mounting member 84.

An alternative configuration and application for the fastener 10 is illustrated in FIG. 5, except that the fastener 10 is directly secured to the substrate member 80 without the mounting member 84. Therefore, the mounting hole 86 does not need to be aligned with the substrate hole 82 and the sleeve seat 26 and shank seat 46 directly engage the substrate member 80. A tubular member, such as an electric line or conduit may be coupled within the coupling member 36 on the sleeve head 22 before or after the fastener 10 is secured to the substrate member 80. Of course, the embodiment illustrated in FIG. 5 may both couple a mounting member 84 as well as a tubular member to a substrate member 80.

As indicated above, the fastener 10 of the present invention provides a secure connection in its coupled position while permitting selective uncoupling when desired. To uncouple the fastener 10 from the coupled position, the outer member 20 is displaced along the longitudinal axis 12 relative to the substrate member 80 and inner member 40 thereby displacing the outer member 20 laterally inward relative to the longitudinal axis to reach a width that allows removal of the fastener. If provided with a pry notch 25, opposing forces are applied to the shank head 44 and sleeve head 22, such as with a flat bladed screwdriver. The fastener 10 may also be moved from the coupled position to the uncoupled position by inserting a flat member between the mounting member 84, or substrate member 80 and the sleeve head 22, specifically the sleeve seat 26 to apply a force along the longitudinal axis 12 that forces the outer member to move relative to the substrate member and inner member 40 and thereby move from the coupled position.

The one-piece fastener 10 is generally formed by molding, and is movable between a coupled position and an uncoupled position. In the illustrated embodiment, the fastener 10 is formed from a nylon material such as nylon 6-6 by plastic injection molding.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

1. A fastener comprising:
an outer member including a cavity and defining a longitudinal axis;
an inner member integral with said outer member wherein one of said inner and outer members includes a pair of axially spaced cams for displacing said outer member outwardly.

2. The fastener of claim 1 wherein said outer member further includes a sleeve head, an insertion tip and an intermediate portion extending between said sleeve head and said insertion tip.

3. The fastener of claim 1 wherein said outer member includes a sleeve head, an insertion tip and an intermediate member having a first section extending from said sleeve head and a second section extending from said insertion tip, said first and second sections meeting to form a first living hinge.

4. A fastener comprising:
an outer member including a cavity;
an inner member integral with said outer member,
a sleeve head, an insertion tip and an intermediate member having a fist section extending from said sleeve head and a second section extending from said insertion tip, said first and second sections meeting to form a first living hinge,
a second living hinge between said intermediate member and said insertion tip,
said insertion tin having a reduced portion with substantially flat, substantially parallel sides at its distal end,

5. A fastener capable of being secured to a substrate member and having an uncoupled position and a coupled position, said fastener comprising:
an outer member defining a cavity, an inner member integrally formed with said outer member, said inner member being disposed in said cavity, and said outer member defining a longitudinal axis and wherein said outer member is moved along said longitudinal axis from the uncoupled position to the coupled position relative to said inner member,
said outer member includes a first arm and a second arm, said inner member being located between said arms and wherein said arms operatively cooperate with said inner member to displace the arms away from the longitudinal axis as said outer member is moved from the uncoupled to the coupled position.
said inner member having a radially outwardly curved first engagement portion and said outer member having a radially inwardly curved second engagement portion, said engagement portions abutting when said outer member is in the counted position and displacing said arms away from said longitudinal axis as said outer member is moved from the coupled position toward the uncoupled position.

6. The fastener of claim 5 wherein said outer member further includes a sleeve head, including a head recess and said inner member includes a shank head configured to be at least partially received within said head recess when said outer member is in the coupled position.

7. A fastener capable of being secured to a substrate member and having an uncoupled position and a coupled position, said fastener comprising:
an outer member defining a cavity, an inner member integrally formed with said outer member, said inner member being disposed in said cavity, and said outer member defining a longitudinal axis and wherein said outer member is moved along said longitudinal axis from the uncoupled position to the coupled position relative to said inner member,
said outer member including a sleeve head, an insertion tip, and an intermediate portion extending between said sleeve head and said insertion tip, said intermediate portion defining said cavity for receiving said inner member and wherein said sleeve bead includes a head recess and said inner member includes a shank head configured to be at least partially received within said head recess when said outer member is in the coupled position,
said sleeve bead further includes an angular notch at least partially within said sleeve head recess to permit pryable release of said outer member from said coupled position.

8. The fastener of claim 7 wherein said sleeve head includes a sleeve seat and said shank head includes a shank seat, said shank seat and said sleeve seat being approximately co-planar when said outer member is in the coupled position.

9. (canceled)

10. The fastener of claim 4, said intermediate portion further including a first arm and a second arm, said first and second arms each including a lower projection, and a cam on said inner member further including a cam surface operative and engaging at least one of said projections to displace said first and said second arms away from said longitudinal axis as said outer member is moved from the uncoupled position to the coupled position.

11. A fastener comprising:
an outer member including a cavity and defining a longitudinal axis;
an inner member integral with said outer member wherein one of said inner and outer members includes a cam for displacing said outer member outwardly,
a first releasable locking mechanism axially spaced from said cam, said first locking mechanism having an upper projection located on one of said outer member and said inner member, and an upper recess located on the other of said outer member and said inner member, said upper projection being disposed within said upper recess when said outer member is in the coupled position.

12. A fastener capable of being secured to a substrate member and having an uncoupled position and a coupled position, said fastener comprising:
an outer member defining a cavity, an inner member integrally formed With said outer member, said inner member being disposed in said cavity, and said outer member defining a longitudinal axis and wherein said outer member is moved along said longitudinal axis from the uncoupled position to the coupled position relative to said inner member, said outer member further including a sleeve head,
a first releasable locking mechanism, said first locking mechanism having an upper projection located on one of said outer member and said inner member, and an upper recess located on the other of said outer member and said inner member, said upper projection being disposed within said upper recess when said outer member is in the counted position,
a second releasable locking mechanism having a lower recess located on one of said inner member and said outer member and a lower projection located on the other of said outer member and said inner member, said lower projection being disposed within said lower recess when said outer member is in the coupled position,
said first and second releasable locking mechanisms resisting motion of said inner member relative to said sleeve head.

13. The fastener of claim 5 wherein said outer member includes a sleeve head, an insertion tip, and an intermediate member having a first section extending from said sleeve head and a second section extending from said insertion tip, said first and second sections meeting to form a first living hinge.

14. The fastener of claim 13 further including a second living hinge between said insertion tip and said intermediate member.

15. (canceled)

16. The fastener of claim 5 wherein said fastener is a one piece injection molded part.

17. The fastener of claim 5 wherein said outer member further includes a sleeve head having a coupling mechanism for coupling an item to the substrate member.

18. A fastener capable being secured to a substrate member and having an uncoupled position and a coupled position, said fastener comprising:
an outer member defining a cavity,
an inner member integrally formed with said outer member, said inner member being disposed in said cavity, and said outer member defining a longitudinal axis and wherein said outer member is moved along said longitudinal axis from the uncoupled position to the coupled position relative to said inner member,
wherein one of said inner and outer members includes a pair of axially said projections, one of said projections engaging a surface the other of said inner and outer members to displace said outer member away from said longitudinal axis as said outer member is moved from the uncoupled position to the coupled position, the other of said projections being coupled to a mating recess in the other of said inner and outer members in the coupled position.

19. A fastener having a longitudinal axis, said fastener capable of securing a first member to a substrate member, said fastener comprising:
an outer member having a sleeve head, an insertion tip, and an intermediate member, said sleeve head including a head recess and said outer member defining a cavity,
an inner member integral with said outer member and extending in said cavity from said insertion tip toward said sleeve head, said inner member including a shank head configured to at least partially fit within said head recess;
a cam for displacing said intermediate member away from the longitudinal axis as said outer member moves from an uncoupled position to a coupled position; and
a releasable locking mechanism axially spaced from said cam for retaining said outer member in said coupled position.

20. The fastener of claim 19 wherein said shank head includes a shank seat and said sleeve head includes a sleeve seat, said sleeve seat and said shank seat being formed so that said shank seat first engages the substrate member as a force is applied along the longitudinal axis to the sleeve head to move the fastener from the uncoupled position to the coupled position and wherein in the coupled position said sleeve seat and said shank seat are approximately aligned.

21. The fastener of claim 20 wherein said locking mechanism is proximate said shank head.

22. The fastener of claim 19 wherein said intermediate member has a first section extending from said sleeve head and a second section extending from said insertion tip, said first and second sections meeting to form a first living hinge.

23. The fastener of claim 18 wherein said outer member further includes a sleeve head including a head recess and said inner member includes a shank head configured to be at least partially received within said head recess when said outer member is in the coupled position.

24. The fastener of claim 23 wherein said locking mechanism is proximate said shank head.

25. The fastener of claim 18 wherein said outer member includes a sleeve head, an insertion tip, and an intermediate member having a first section extending from said sleeve head and a second section extending from said insertion tip, said first and second sections meeting to form a first living hinge.

26. The fastener of claim 1 wherein said outer member further includes a sleeve head including a head recess and said inner member includes a shank head configured to be at least partially received within said head recess when said outer member is in the coupled position.

27. The fastener of claim 11 wherein said outer member further includes a sleeve head including a head recess and said inner member includes a shank head configured to be at least partially received within said head recess when said outer member is in the coupled position.

28. The fastener of claim 27 wherein said locking mechanism is proximate said shank head.

29. The fastener of claim 11 wherein said outer member includes a sleeve head, an insertion tip, and an intermediate member having a first section extending from said sleeve head and a second section extending from said insertion tip, said first and second sections meeting to form a first living binge.
